(19) United States
(12) Patent Application Publication
(10) Pub. No.: US 2024/0113914 A1
(43) Pub. Date: Apr. 4, 2024

(54) LOW POWER PROCESSING OF REMOTE MANAGEABILITY REQUESTS

(71) Applicant: Advanced Micro Devices, Inc., Santa Clara, CA (US)

(72) Inventors: Sriram Sambamurthy, Austin, TX (US); Indrani Paul, Austin, TX (US); David Boardman Kramer, Austin, TX (US); Madhusudan Chilakam, Boxborough, MA (US)

(21) Appl. No.: 17/937,262

(22) Filed: Sep. 30, 2022

(51) Int. Cl. H04L 12/46; H04L 49/109

(52) U.S. Cl. CPC H04L 12/4616; H04L 49/109

(57) ABSTRACT

An apparatus and method for efficiently performing power management for multiple clients of a semiconductor chip that supports remote manageability. In various implementations, a network interface receives a packet, and sends at least an indication of the packet to a manageability processing circuitry (MPC) of a processing node with multiple clients for processing tasks. The MPC determines whether a client or itself is a destination needed to process the packet. If the destination is the MPC, then packet processing is done by the MPC without involvement from the clients, which can be in an idle state. For example, the MPC can process a remote manageability packet requesting diagnostic information from one or more clients of the processing node. The network interface and the MPC use a sideband communication channel for data transmission, which foregoes lane training for further reduction in latency and power consumption.

### BACKGROUND

### Description of the Relevant Art

A variety of computing devices utilize heterogeneous integration, which integrates multiple types of functional blocks for providing system functionality. A variety of choices exist for system packaging to integrate the multiple types of functional blocks. In some computing devices, a system-on-a-chip (SOC) is used, whereas, in other computing devices, smaller and higher-yielding chips are packaged as large chips in multi-chip modules (MCMs). The variety of computing devices can be used by an organization in a distributed deployment manner. For example, an organization has a datacenter accessible through a private network only to the staff of the organization. Examples of the organization is a financial institution, a hospital, a local business, a corporation, a university, and so forth.

A system administrator loads particular applications and firmware on the variety of computing devices that are used across the organization. Over time, the system administrator monitors, updates, and repairs this software. Rather than physically bring the computing device to the system administrator, remote manageability tools are used for these purposes. The remote manageability tools are also multiple sources of service requests that target one or more functional blocks of a computing device. To service these requests, an appreciable amount of time is spent and an appreciable amount of power is consumed by the computing device.

The power consumption of modern integrated circuits (ICs) has become an increasing design issue with each generation of semiconductor chips. As power consumption increases, more costly cooling systems such as larger fans and heat sinks must be utilized in order to remove excess heat and prevent IC failure. However, cooling systems increase system costs. The IC power dissipation constraint is not only an issue for portable computers and mobile communication devices, but also for desktop computers and servers utilizing high-performance microprocessors.

In view of the above, efficient methods and systems for performing power management for multiple clients of a semiconductor chip that supports remote manageability are desired.

### BRIEF DESCRIPTION OF THE DRAWINGS

FIG. 1 is a generalized block diagram of a computing system that performs power management for multiple clients of a semiconductor chip that supports remote manageability.

FIG. 2 is a generalized block diagram of a manageability module circuit.

FIG. 3 is a generalized block diagram of a computing system that performs power management for multiple clients of a semiconductor chip that supports remote manageability.

FIG. 4 is a generalized block diagram of a computing system that performs power management for multiple clients of a semiconductor chip that supports remote manageability.

FIG. 5 is a generalized block diagram of a method for efficiently performing power management for multiple clients of a semiconductor chip that supports remote manageability.

FIG. 6 is a generalized block diagram of a method for efficiently performing power management for multiple clients of a semiconductor chip that supports remote manageability.

FIG. 7 is a generalized block diagram of a method for efficiently performing power management for multiple clients of a semiconductor chip that supports remote manageability.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently performing power management for multiple clients of a semiconductor chip that supports remote manageability are contemplated. In various implementations, a computing system includes multiple remote computing devices of an organization that communicate with a system administrator computing device through a network. Examples of the network are the Internet and an intranet network of the organization. In some implementations, a remote computing device includes a network interface with circuitry that includes a packet processing circuit (PPC). The hardware, such as circuitry, of the network interface communicates with a processing node on the motherboard such as a system on a chip (SoC). In addition, the remote computing device includes a manageability processing circuit (MPC) in the SoC. In various implementations, each of the PPC of the network interface and the MPC of the SoC uses an always-on power domain. By not requiring any latency for waking up from an idle state, the PPC of the network interface and the MPC of the SoC reduce latency for processing remote manageability packets and other types of packets.

In some implementations, the circuitry of the network interface is included in a network interface card in a slot on the motherboard of the remote computing device. Therefore, relative to the location of the processing node, the location of the network interface is considered local, and as used herein, the term “network interface” can also refer to “local area network circuitry.” In other implementations, the circuitry of the network interface (or local area network circuitry) is included in a local area network on motherboard (LOM) with circuitry in a semiconductor chip directly embedded on the motherboard. In an implementation, the circuitry of the network interface provides the functionality of a wireless local area network (WLAN) that supports a wireless connection with the network.

The PPC of the network interface receives a packet such as a remote manageability packet. In some implementations, this PPC is unable to process the packet, and sends an indication of the packet, such as at least header information of the packet, to the MPC of the SoC. The circuitry of this MPC determines a destination that can process the packet. The destination is one of the clients of the SoC or the MPC itself. As used herein, a “client” refers to an integrated circuit with data processing circuitry and local memory, which has tasks assigned to it by a scheduler such as an operating system (OS) scheduler or other. Examples of tasks are software threads of a process of an application, which are scheduled by the OS scheduler.

In some implementations, the MPC of the SoC is aware of diagnostic information or operating mode information of the SoC that is requested by a remote manageability packet. Similarly, in some implementations, the MPC is capable of providing information for other types of packets. The MPC of the SoC responds to the PPC of the network interface with this information. The PPC of the network interface and the MPC of the Soc use a sideband communication channel for data transmission, rather than a high-speed input/output (I/O) communication channel between the network interface and the SoC. In contrast to the high-speed I/O communication channel, the sideband communication channel does not use lane training steps when transitioning from an idle state. Therefore, the sideband communication channel provides reduced latency and reduced power consumption compared to the high-speed I/O communication channel. If the MPC determines that the packet can be processed by is the MPC of the SoC, then the MPC receives the full packet from the PPC of the network interface. Following, the MPC processes the packet without involvement from the clients of the SoC. If the clients of the SoC are in a low power operating mode, such as an idle operating mode, the clients of the SoC are able to remain in the low power operating mode the remote manageability packet is processed. Further details of the PPC of the network interface and the MPC of the SoC are provided in the following discussion.

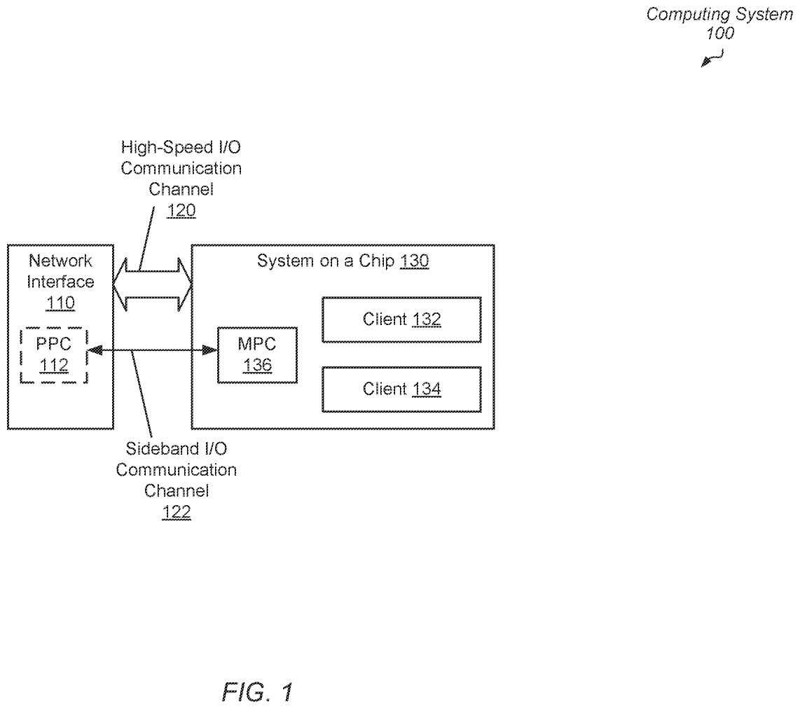

Turning now to FIG. 1, a generalized block diagram is shown of a computing system 100 that performs power management for multiple clients of a semiconductor chip that supports remote manageability. As shown, the computing system 100 includes at least the network interface 110 and the system on a chip (SoC) 130. The network interface 110 includes hardware, such as circuitry, for supporting one or more communication protocols and processing one or more types of received requests. The hardware, such as circuitry, of the SoC 130 provides a variety of functionalities. Each of the network interface 110 and the SoC 130 includes circuitry that supports a high-speed input/output (I/O) communication channel 120 and a lower power sideband I/O communication channel 122. In some implementations, the network interface 110 includes a packet processing circuit (PPC) 112 that is capable of processing one or more types of received packets. In other implementations, the network interface 110 does not include the PPC 112. Therefore, the border of the PPC 112 includes dashed lines to indicate that the PPC 112 is not always included in the network interface 110. As shown, the SoC 130 includes a manageability processing circuit (MPC) 136. In various implementations, the network interface 110 communicates (transfers packets and data) with the MPC 136 through the lower power sideband I/O communication channel 122.

As used herein, the term “functional block” refers to a circuit or circuitry that performs a variety of functionalities. In various implementations, the SoC 130 includes numerous functional blocks. Some of the functional blocks perform the functionality of an input/output interface controller such as receiving, storing, and transmitting request packets and response packets. Other functional blocks receive and direct interrupts such as an interrupt controller. Still other functional blocks generate clock signals, or transfer packets through a communication fabric. Yet still other functional blocks, which are referred to as clients, process requests and generate responses. As used herein, a “client” refers to an integrated circuit with data processing circuitry and local memory. Although two clients 132 and 134 are shown, in various implementations, the SoC 130 uses any number of clients. Examples of clients are a general-purpose central processing unit (CPU), a parallel data processing unit with a relatively wide single-instruction-multiple-data (SIMD) microarchitecture, a multimedia integrated circuit, one of a variety of types of an application specific integrated circuit (ASIC), a digital signal processor (DSP), a field programmable gate array (FPGA), one or more microcontrollers, and so forth.

The network interface 110 supports a communication protocol that enables communication with a network (not shown). The network includes multiple switches, routers, cables, wireless transmitters, and the Internet for transferring messages and data. Accordingly, in various implementations, the network interface 110 supports the Hypertext Transfer Protocol (HTTP) for communication across the World Wide Web. In some implementations, the network interface 110 supports a communication protocol of an intranet network of a particular organization. The network interface 110 includes one or more queues for storing requests, responses, and messages. The circuitry of the network interface 110 also builds packets for transmitting to the network, and disassembles packets received from the network. The functionality of the network interface 110 can be included on a network adapter card. In another implementation, the functionality of the network interface 110 is included on a local area network on motherboard (LOM), which is a single chip or a chipset directly embedded on the motherboard of a desktop computer. In such an implementation, the circuitry of the network interface 110 is attached to the motherboard, and a connector (or slot or socket) is made available on the motherboard, since a network adapter card is not used.

The network interface 110 is capable of supporting one or more of wired connections and wireless connections to the network. When supporting a wireless network connection, the network interface 110 supports a wireless local area network (WLAN). The WLAN is a wireless information distribution method between an access point, such as a router, and an endpoint such as one of a variety of computing devices that uses at least the circuitry of the computing system 100. Examples of the computing devices are desktop computers and mobile computing devices such as laptops, tablet computers, smartphones, smartwatches, netbook computers, and so forth. The information is transmitted and received between the router and the endpoint using radio frequency signals. The use of the WLAN allows a user to move the computing device around an area while maintaining a connection with the network.

The network interface 110 also supports at least two communication channels for communication with the system on a chip (SoC) 130. The lower power sideband I/O communication channel 122 (or sideband communication channel 122) supports a lower speed (or data rate) than the high-speed I/O communication channel 120. In addition, the sideband communication channel 122 consumes less power than the high-speed I/O communication channel 120 (or communication channel 120). Further, the use of the sideband communication channel 122 avoids performing any lane training steps, which are done for the high-speed I/O communication channel 120 when exiting an idle state. Performing the lane training of the high-speed I/O communication channel 120 also involves waking up one or more integrated circuits of the SoC 130. Therefore, both latency and power consumption increase when the high-speed I/O communication channel 120 is used for data transmission rather than the sideband communication channel 122. In an implementation, the communication channel 120 supports a communication protocol such as the Peripheral Component Interconnect Express (PCIe) protocol, and the sideband communication channel 122 supports the I²C (Inter-Integrated Circuit, eye-squared-C) protocol. However, in other implementations, the support of a variety of other communication protocols is possible and contemplated.

A system administrator loads particular applications and firmware on a variety of computing devices that are used across an organization. The organization has a datacenter accessible through a private network only to the staff of the organization. Examples of the organization is a financial institution, a hospital, a local business, a corporation, a university, and so forth. Over time, the system administrator monitors, updates, and repairs this software running on the remote computing devices. Rather than have a user physically bring the computing device to the system administrator, remote manageability tools are used for these purposes.

The remote manageability tools use a network to communicate with the remote computing devices and provide the necessary services. Examples of the network are the Internet and an intranet network corresponding to an organization. Examples of the services are monitor or request diagnostic information, upgrade applications, install or deploy applications, and repair applications. When running the remote manageability tools, the computing device of the system administrator communicates through the Internet (or an intranet network) with the network interface 110 of a remote user's computing device. The remote manageability tools provide a graphical user interface (GUI) or an open text window for the system administrator to allow the system administrator to determine the functionality of services to use, to identify which remote computing devices receive the services, and to determine a schedule for each of the services.

In implementations where the network interface 110 does not include the PPC 112, the network interface 110 forwards each received packet to the MPC 136 through the sideband communication channel 122. In other implementations, the network interface 110 includes the PPC 112. In various implementations, each of the PPC 112 and the MPC 136 uses an always-on power domain. By not requiring any latency for waking up from an idle state, the PPC 112 and the MPC 136 reduce latency for processing packets. In some implementations, the PPC 112 includes circuitry that can process the received packet. If so, the PPC 112 processes the packet and sends a corresponding response to the source of the packet. If not, in some implementations, the PPC 112 is capable of determining a destination for the received packet that will process the packet. The destination is one of the clients 132 and 134 or the MPC 136. If not, then the PPC 112 sends an indication of the packet, such as at least header information of the packet, to the MPC 136. The circuitry of the MPC 136 determines the destination that will process the packet and responds to the PPC 112 with this information. As described earlier, the PPC 112 and the MPC 136 use the sideband communication channel 122 for transferring data with one another.

In some implementations, the circuitry of the MPC 136 includes a dedicated processor core of the SoC 130, a microcontroller of the SoC 130, an ASIC of the SoC 130, or other. If the determined destination is the MPC 136, then the PPC 112 sends the packet through the sideband communication channel 122 to the MPC 136. The MPC 136 processes the packet and sends a response through the sideband communication channel 122 to the PPC 112. Alternatively, the MPC 136 sends the response through the sideband communication channel 122 to other circuitry of the network interface 110 when the PPC 112 is not used. Afterward, the PPC 112 (or other circuitry of the network interface 110) sends a response, based on the processing of the packet, to the source. When the packet is a remote manageability packet, the source is a system administrator computing device. If the SoC 130 is in a low power operating mode, such as an idle operating mode, then the SoC 130 is able to remain in the low power operating mode despite reception of the packet. Accordingly, power consumption of the computing system 100 is reduced. If the determined destination is one of the clients 132 and 134 instead of the MPC 136, then the PPC 112 (or other circuitry of the network interface 110) sends the packet through the communication channel 120 to the corresponding one of the clients 132 and 134. At a later time, the PPC 112 (or other circuitry of the network interface 110) sends a response to the source based on the processing of the packet by the corresponding one of the clients 132 and 134.

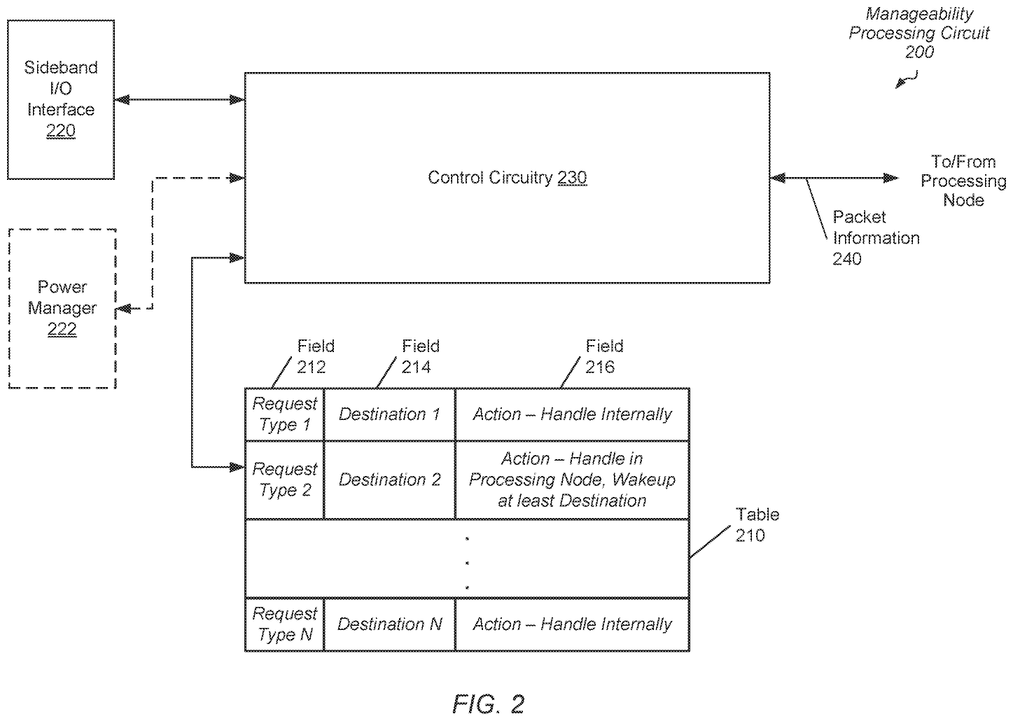

Referring to FIG. 2, a generalized block diagram is shown of a manageability processing circuit (MPC) 200. As shown, the MPC 200 includes the table 210 and the control circuitry 230. The control circuitry 230 transfers data with a sideband input/output (I/O) interface 220 that supports a communication protocol with a sideband I/O communication channel. The control circuitry 230 transfers data, such as packet information 240, with a processing node such as a system on a chip (SoC). In some implementations, the control circuitry 230 communicates with a power manager 222 that determines whether the MPC 200 operates in an idle state or an active state. The table 210 includes multiple table entries (or entries), each storing information in multiple fields such as at least fields 212-216. In various implementations, the MPC 200 includes similar functionality as the MPC 136 of the computing system 100 (of FIG. 1).

The table 210 is a data storage area implemented with one of flip-flop circuits, a random access memory (RAM), a content addressable memory (CAM), or other. Although particular information is shown as being stored in the fields 212-216 and in a particular contiguous order, in other implementations, a different order is used and a different number and type of information is stored. As shown, field 212 stores a request type of a packet that specifies one of a variety of request types. Examples of the request types of a packet are a remote manageability monitor or report type for inspections of log files to determine usage information of applications and performance of hardware components, a remote manageability upgrade type, a remote manageability repair type, a scheduled upgrade type, and so on. Another request type is a scheduled monitored type for determining the processing capabilities of hardware components (number of processors, maximum supported clock frequency of the processors, the types of available processors), and determining network bandwidth usage, network traffic patterns, number, and amount of network connection delays, and so on. A system administrator can send a remote manageability packet requesting one or more of these same types of information.

The field 214 stores a destination for servicing the particular request type stored in field 212. Examples of the destination are the MPC 200 and one of multiple clients of the processing node, such as a CPU or an ASIC within an SoC. The field 216 stores an action to take for processing a packet based on the information stored in the fields 212 and 214. For example, some packets are handled by the MPC 200, and therefore, no communication using the packet information 240 is necessary. Other packets, however, require the use of one of the clients, which can include waking up a client that is currently in an idle state.

The control circuitry 230 receives packets from the sideband I/O interface 220, and with the use of the table 210 and at least the packet header information, determines an action to take to process the packet. In various implementations, the control circuitry 230 receives packets and indications of packets via the sideband I/O interface 220 from a network interface. In an implementation, the network interface includes a packet processing circuit with the functionality of the PPC 112 (of FIG. 1). In some implementations, when one or more clients of the processing node process packets, the control circuitry 230 transmits the packets to the processing node via the packet information 240. However, for data transmission with the network interface, the MPC 200 uses the sideband I/O interface 220, which consumes less power than an alternate high-speed communication channel between the network interface and the processing node. For example, the sideband I/O interface 220 does not support lane training steps for the corresponding sideband communication channel. However, the sideband I/O interface 220 is also slower.

In some implementations, the MPC 200 uses an always-on power domain. In other implementations, the MPC 200 is capable of transitioning from an active state to an idle state. An external power manager or power multiplexer communicates with the power manager 222 to indicate the operating mode or power-performance state (P-state) for the MPC 200. In an implementation, when the MPC 200 is in an idle state, and a packet is sent from the external network interface, the external power manager asserts a signal to the power manager 222 that indicates the MPC 200 should wake up and transition to an active state. Afterward, the MPC 200 receives an indication of the packet, such as a packet header, via the sideband I/O interface 220.

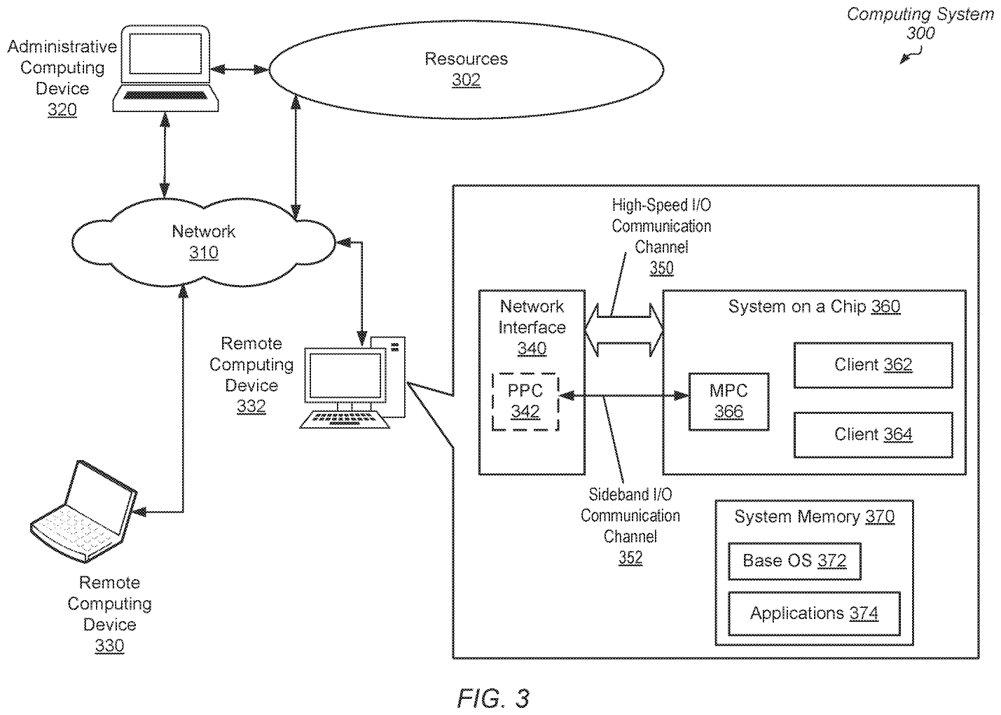

Referring to FIG. 3, a generalized block diagram is shown of a computing system 300 that performs power management for multiple clients of a semiconductor chip that supports remote manageability. As shown, the computing system 300 includes the administrative computing device 320 connected to the resources 302 and connected through the network 310 to the multiple client devices such as at least remote computing devices 330 and 332. The remote computing devices 330 and 332 also access the resources 302 through the network 310. In some implementations, the resources 302 includes a server array (not shown) that is a grid of a relatively high number of server computers such as hundreds or thousands of server computers (or servers). The server array provides storage of user data and provides access to multiple different types of applications to authorized users such as staff of the organization. An organizational center, which is not shown for ease of illustration, supports an internal network that uses at least the server array of the resources 302.

The servers of the resources 302 can include a variety of server types such as database servers, computing servers, application servers, mail servers, and file servers. In some implementations, the servers of the resources 302 and the remote computing devices 330 and 332 operate with a client-server architectural model. Although two remote computing devices 330 and 332 are shown, in various implementations, the computing system 300 uses any number of remote computing devices. The remote computing devices 330 and 332 include desktop computers and mobile computing devices such as laptops, tablet computers, smartphones, smartwatches, netbook computers, and so forth. A system administrator or other user manages the resources 302 and the remote computing devices 330 and 332 using the administrative computing device 320 (or computing device 320). The computing device 320 is any of a variety of computing devices such as a desktop computer, a laptop computer, a tablet computer, a smartphone, and so on.

As shown, similar to other remote computing devices (such as remote computing device 330), the remote computing device 332 includes the circuitry of at least the multiple hardware components 340-370. In various implementations, the network interface 340, the packet processing circuit (PPC) 342, the SoC 360, the clients 362 and 364, and the manageability processing circuit (MPC) 366 have the same functionality respectively as described earlier for the network interface 110, the (PPC) 112, the SoC 130, the clients 132 and 134, and the MPC 136 of the computing system 100 (of FIG. 1). The MPC 366 also has similar functionality as described earlier for MPC 200 (of FIG. 2).

The network interface 340 includes hardware, such as circuitry, for supporting a communication protocol that enables communication with the network 310. The network interface 340 includes one or more queues for storing requests, responses, and messages. The circuitry of the network interface 340 also builds packets for transmitting to the network 310, and disassembles packets received from network 310. The functionality of the network interface 340 can be included on a network adapter card. In another implementation, the functionality of the network interface 340 is included on a local area network on motherboard (LOM), which is a single chip or a chipset directly embedded on the motherboard of a desktop computer that supports communication with the network 310. In such an implementation, the circuitry of the network interface 340 is attached to the motherboard, and a connector (or slot or socket) is made available on the motherboard, since a network adapter card is not used. The network interface 340 is capable of supporting one or more of wired connections and wireless connections to the network 310.

The network interface 340 supports two communication channels for communication with the system on a chip (SoC) 360. As shown, the network interface 340 supports a high-speed input/output (I/O) communication channel 350 and a lower power sideband I/O communication channel 352. The lower power sideband I/O communication channel 352 (or sideband communication channel 352) supports a lower speed (or data rate) than the high-speed I/O communication channel 350 (or communication channel 350). In addition, the sideband communication channel 352 consumes less power than the communication channel 350. In an implementation, the communication channel 350 supports the communication protocols are the Peripheral Component Interconnect Express (PCIe) protocol, and the sideband communication channel 352 supports the I²C (Inter-Integrated Circuit, eye-squared-C) protocol. However, in other implementations, the support of a variety of other communication protocols is possible and contemplated.

The system memory 370 stores a base operating system (OS) 372, one or more applications 374, and user data and result data (not shown). The system memory 370 includes any suitable memory devices such as one or more RAMBUS dynamic random access memories (DRAMs), synchronous DRAMs (SDRAMs), DRAM, static RAM, and so forth. The address space of the computing system 300 is divided among multiple memories corresponding to the multiple cores. In an implementation, the coherency point for an address is a system memory controller (not shown) for the system memory 370, which communicates with the system memory 370 storing bytes corresponding to the address. The system memory controller includes control circuitry for interfacing to memories of the system memory 370 and queues or other data storage areas for storing memory access requests and memory access responses.

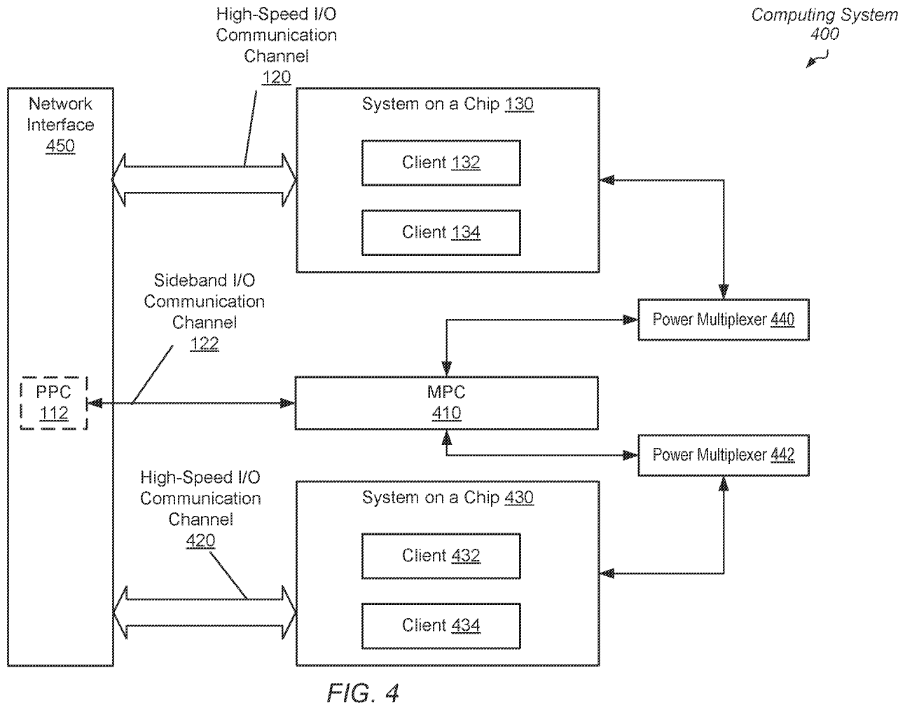

Turning now to FIG. 4, a generalized block diagram is shown of a computing system 400 that performs power management for multiple clients of a semiconductor chip that supports remote manageability. Hardware components that include circuitry and were described earlier are numbered identically. As shown, the computing system 400 includes at least the network interface 450, the system on a chip (SoC) 130, the manageability processing circuit (MPC) 410, the SoC 430, and the power multiplexers 440 and 442. Rather than include an internal MPC, the SoC 130 relies on the external MPC 410. However, in other implementations, the functionality of the circuitry of the MPC 410 is included in one of the SoC 130 and the SoC 430.

Similar to the SoC 130 including clients 132 and 134 for processing tasks, the SoC 430 includes clients 432 and 434 for processing tasks. The network interface 450 includes extra circuitry for supporting the high-speed I/O communication channel 420 for data transmission with the SoC 430. In various implementations, each of the high-speed I/O communication channels 120 and 420 support the same communication protocol, which uses lane training steps when waking up from an idle state.

In some implementations, the network interface 450 does not include the PPC 112. In such implementations, the network interface 450 sends an indication of each received packet to the MPC 410 through the sideband I/O communication channel 122. In implementations where the network interface 450 includes the PPC 112, in contrast to the PPC 112, the MPC 410 does not use an always-on power domain. Therefore, the MPC 410 is capable of transitioning from active state to an idle state. In some implementations, the power multiplexers 440 and 442 determine a corresponding P-state for the SoC 130, the SoC 430, and the MPC 410. Additionally, the power multiplexers 440 and 442 can send control signals that indicate which power rails to disconnect. In other implementations, the power multiplexers 440 and 442 pass on control signals from an external power manager (not shown). Although latency can increase for packet processing when the MPC 410 is in an idle state or other power gating condition, the ability of the MPC 410 to use the idle state further reduces power consumption for the computing system 400.

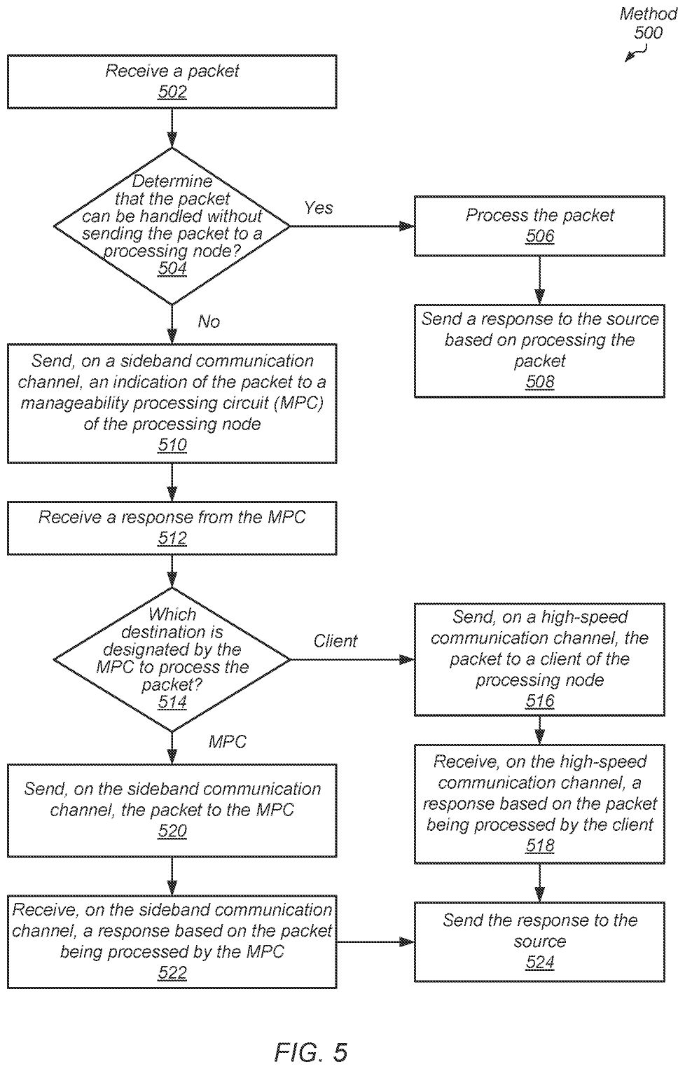

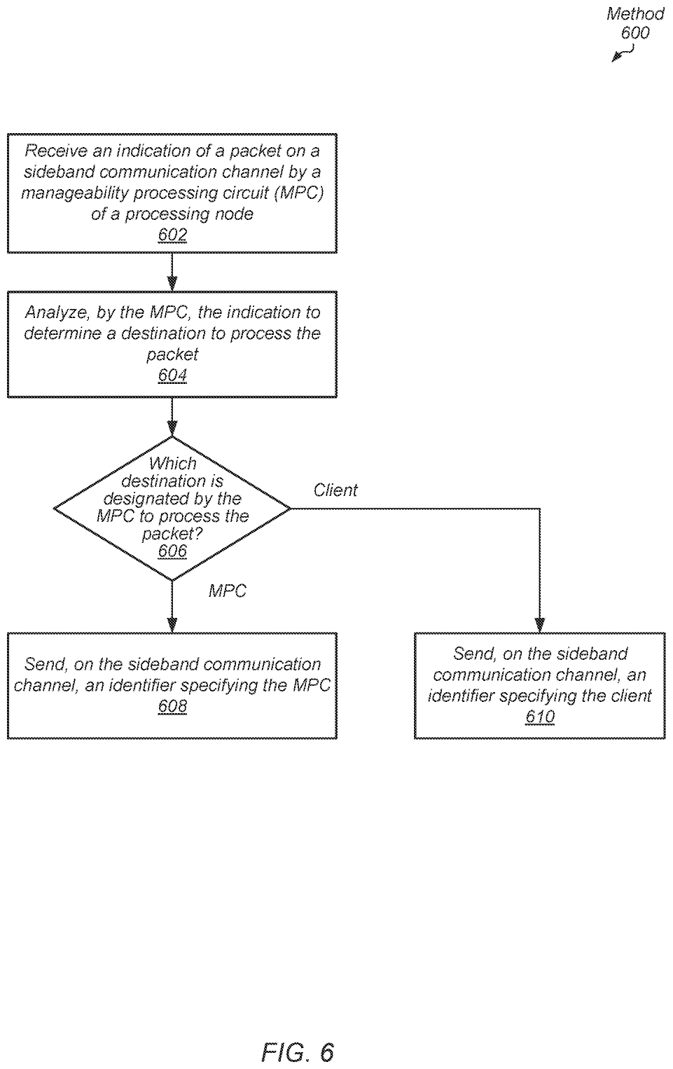

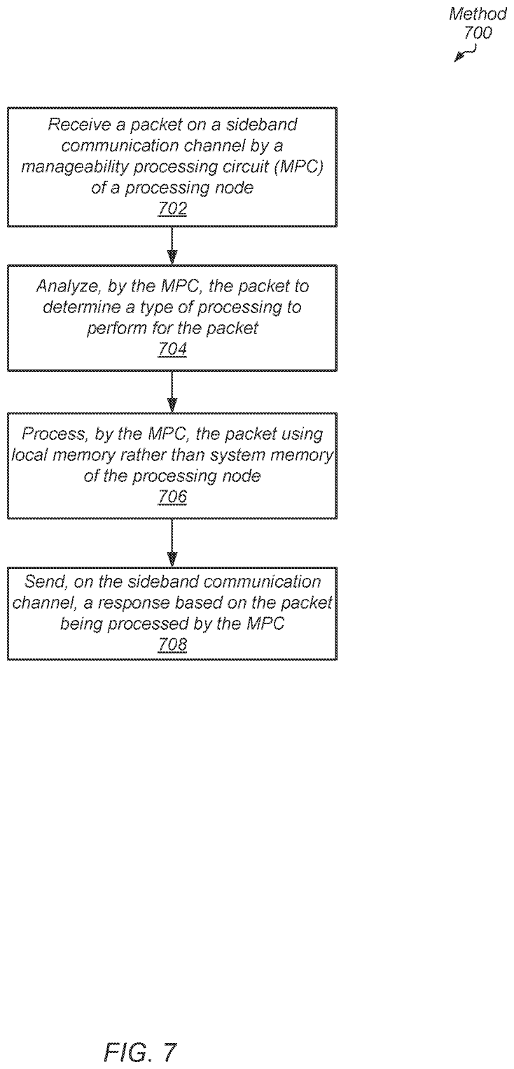

Turning now to FIG. 5, a generalized block diagram is shown of a method 500 for efficiently performing power management for multiple clients of a semiconductor chip that supports remote manageability. For purposes of discussion, the steps in this implementation (as well as in FIGS. 6-7) are shown in sequential order. However, in other implementations some steps occur in a different order than shown, some steps are performed concurrently, some steps are combined with other steps, and some steps are absent.

In various implementations, a computing system includes multiple remote computing devices of an organization that communicate with a system administrator computing device through a network. Examples of the network are the Internet and an intranet network of the organization. A remote computing device includes a network interface. In some implementations, the network interface is a network interface card in a slot on the motherboard of the remote computing device. In other implementations, the network interface is a local area network on motherboard (LOM) with circuitry in a semiconductor chip directly embedded on the motherboard. In an implementation, the network interface is a wireless local area network (WLAN) that supports a wireless connection with the network. The network interface communicates with a processing node on the motherboard such as a system on a chip (SoC). In various implementations, the network interface uses at least two communication channels for communicating with the processing node. The network interface receives a packet (block 502).

In some implementations, the network interface includes circuitry that is capable of determining a destination for the received packet. For example, the network interface includes a packet processing circuit (PPC) that includes the functionality of the PPC 112 (of FIG. 1). In other implementations, the network interface does not include such circuitry. If the network interface determines that the packet can be handled (or processed) without sending the packet to the processing node (“yes” branch of the conditional block 504), then the network interface processes the packet (block 506). For example, the PPC of the network interface processes the packet. The PPC of the network interface is able to prepare a response packet without involvement from the processing node. If the processing node is in a low power operating mode, such as an idle operating mode, then the processing node is able to remain in the low power operating mode despite reception of the packet.

Afterward, the network interface sends a response to the source based on processing the packet (block 508). For example, the PPC or other circuitry of the network interface sends the response packet that includes the requested information to the source of the request packet. The response packet is sent through the network (the Internet or an intranet network). If the network interface (the PPC or other circuitry) determines that the packet has to be handled (or processed) by sending the packet to the processing node (“no” branch of the conditional block 504), then the network interface sends, on a sideband communication channel, an indication of the packet to a manageability processing circuit (MPC) of the processing node (block 510). In various implementations, this MPC has the functionality of the MPC 136 (of FIG. 1), the MPC 200 (of FIG. 2) or the MPC 410 (of FIG. 4). The indication can include a header of the packet and one or more other fields of the packet without including all the information of the packet. The sideband communication channel supports a lower speed (or data rate) than a high-speed I/O communication channel between the network interface and the processing node. In addition, the sideband communication channel consumes less power than the high-speed I/O communication channel. Based on the received indication, the MPC of the processing node determines a destination for processing the packet.

The network interface receives a response from the MPC of the processing node through the sideband communication channel (block 512). If the received response indicates that the MPC of the processing node designates a client of the processing node to process the packet (“Client” branch of the conditional block 514), then the network interface sends, on the high-speed communication channel, the packet to the designated client of the processing node (block 516). At a later time, the network interface receives, on the high-speed communication channel, a response based on the packet being processed by the client (block 518). Afterward, the network interface sends a response to the source of the request packet based on the received response from the processing node (block 524). For example, the PPC or other circuitry of the network interface sends the response packet that includes the requested information to the source. The response packet is sent through the network (the Internet or an intranet network).

If the received response indicates that the MPC of the processing node designates the MPC of the processing node to process the packet (“MPC” branch of the conditional block 514), then the network interface sends, on the sideband communication channel, the packet to the MPC of the processing node (block 520). In one example, based on the received indication, the MPC determines that the packet is a remote manageability packet from a system administrator computing device. The remote manageability packet requests diagnostic information or operating mode information of the processing node of which the MPC is aware or able to access without waking up any clients of the processing node. In another example, based on the received indication, the MPC determines that the packet is another type of request packet targeting information of which the MPC is aware or able to access without waking up any clients of the processing node. At a later time, the network interface receives, on the sideband communication channel, a response based on the packet being processed by the MPC of the processing node (block 522). Afterward, the network interface sends a response to the source based on the received response from the MPC of the processing node (block 524).

Turning now to FIG. 6, a generalized block diagram is shown of a method 600 for efficiently method for efficiently performing power management for multiple clients of a semiconductor chip that supports remote manageability. A manageability processing circuit (MPC) of a processing node, such as a system-on-a-chip (SOC), receives an indication of a packet from an external network interface on a sideband communication channel (block 602). The indication can include a header of the packet and one or more other fields of the packet without including all the information of the packet. The sideband communication channel supports a lower speed (or data rate) than a high-speed I/O communication channel between a network interface and the processing node. The MPC of the processing node analyze the indication to determine a destination to process the packet (block 604).

If the MPC of the processing node determines a client of the processing node should process the packet (“Client” branch of the conditional block 606), then the MPC of the processing node sends, on the sideband communication channel, an identifier specifying the client (block 610). However, if the MPC of the processing node determines the MPC of the processing node should process the packet (“MPC” branch of the conditional block 606), then the MPC of the processing node sends, on the sideband communication channel, an identifier specifying the MPC (block 608). In some implementations, the circuitry of the MPC of the processing node is aware of diagnostic information or operating mode information of the processing node that is requested by a remote manageability packet or another type of request packet. The MPC of the processing node is able to determine what information is requested by the packet from the indication received earlier (such as in block 602). By having the PMC later process the packet, such as a remote manageability packet, the clients of the processing node are able to remain in an idle operating mode, which reduces power consumption of the computing system.

Referring to FIG. 7, a generalized block diagram is shown of a method 700 for efficiently method for efficiently performing power management for multiple clients of a semiconductor chip that supports remote manageability. A manageability processing circuit (MPC) of a processing node, such as a system-on-a-chip (SOC), receives a packet on a sideband communication channel (block 702). The MPC of the processing node analyze the packet to determine a type of processing to perform for the packet (block 704). In some implementations, the MPC stored an indication of this determination from a previous analysis of at least the packet header. Such a step was described earlier for block 604 of method 600 (of FIG. 6).

The circuitry of the MPC of the processing node is aware of diagnostic information or operating mode information of the processing node that is requested by the packet, such as a remote manageability packet. The MPC of the processing node processes the packet using local memory of the MPC rather than system memory of the processing node (block 706). By doing so, the MPC of the processing node does not communicate with the system memory controller of the processing node. Therefore, if the system memory controller is in an idle state, then the system memory controller can remain in the idle state. The MPC of the processing node sends, on the sideband communication channel, a response based on the packet being processed by the MPC (block 708). By processing the packet without involvement of circuitry, such as clients, of the processing node, the MPC of the processing node does not interrupt any clients. These clients can remain in an idle state if they were already in the idle state. Therefore, power consumption of the computing system decreases.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
control circuitry configured to:
receive an indication of a first packet from local area network circuitry;
analyze the indication to determine whether a destination for processing the first packet is the apparatus or one of a plurality of clients of a processing node that comprises circuitry for processing tasks; and
send a first identifier to the local area network circuitry specifying the apparatus, in response to determining the destination to process the first packet is the apparatus.

2. The apparatus as recited in claim 1, further comprising a sideband input/output interface, wherein the sideband input/output interface is configured to communicate with the local area network circuitry through a sideband communication channel that is a lower speed and lower power channel than a high-speed communication channel between the local area network circuitry and the processing node.

3. The apparatus as recited in claim 2, wherein each of the apparatus and a packet processing circuit of the local area network circuitry utilizes an always-on power domain.

4. The apparatus as recited in claim 2, wherein the sideband input/output interface, when transitioning from an idle state, does not support lane training steps of the sideband communication channel.

5. The apparatus as recited in claim 2, further comprising local memory, wherein the control circuitry is further configured to access the local memory for processing the first packet in place of accessing system memory of the processing node.

6. The apparatus as recited in claim 2, wherein:
the control circuitry is further configured to send, via the sideband input/output interface and the sideband communication channel, a response to the local area network circuitry based on processing of the first packet by the control circuitry while each of the plurality of clients of the processing node remains in an idle state; and
the first packet is a remote monitoring packet requesting diagnostic information from one or more of the plurality of clients of the processing node.

7. The apparatus as recited in claim 2, wherein:
the sideband input/output interface is further configured to receive, via the sideband communication channel, an indication of a second packet from the local area network circuitry; and
the control circuitry is further configured to send, via the sideband input/output interface and the sideband communication channel, a second identifier to the local area network circuitry specifying a given client of the plurality of clients, in response to determining the destination to process the second packet is the given client.

8. A method, comprising:
receiving, by a manageability processing circuit (MPC) of a processing node, an indication of a first packet from local area network circuitry;
analyzing, by the MPC, the indication to determine whether a destination to process the first packet is the MPC or one of a plurality of clients of the processing node, each comprising circuitry for processing tasks; and
sending, by the MPC to the local area network circuitry, a first identifier specifying the MPC, in response to determining the destination to process the first packet is the MPC.

9. The method as recited in claim 8, further comprising communicating, by the MPC, with the local area network circuitry through a sideband communication channel that is a lower speed and lower power channel than a high-speed communication channel between the local area network circuitry and the processing node.

10. The method as recited in claim 9, further comprising utilizing an always-on power domain by each of the MPC and a packet processing circuit of the local area network circuitry.

11. The method as recited in claim 9, further comprising transitioning from an idle state, by the sideband communication channel, without supporting lane training steps of the sideband communication channel.

12. The method as recited in claim 9, further comprising accessing, by the MPC, local memory for processing the first packet in place of accessing system memory of the processing node.

13. The method as recited in claim 9, further comprising sending, by the MPC via the sideband communication channel, a response to the local area network circuitry based on processing of the first packet by the MPC while each of the plurality of clients of the processing node remains in an idle state, wherein the first packet is a remote monitoring packet requesting diagnostic information from one or more of the plurality of clients of the processing node.

14. The method as recited in claim 9, further comprising:
receiving, by the MPC via the sideband communication channel, an indication of a second packet from the local area network circuitry; and
sending, by the MPC via the sideband communication channel, a second identifier to the local area network circuitry specifying a given client of the plurality of clients, in response to determining the destination to process the second packet is the given client.

15. A computing system comprising:
local area network circuitry; and
a processing node comprising a manageability module circuit (MPC) and a plurality of clients, each comprising circuitry for processing tasks; and
wherein the MPC is configured to:
receive an indication of a first packet from the local area network circuitry;
analyze the indication to determine whether a destination to process the first packet is the MPC or a client of the plurality of clients; and
send a first identifier to the local area network circuitry specifying the MPC, in response to determining the destination to process the first packet is the MPC.

16. The computing system as recited in claim 15, further comprising a sideband communication channel between the MPC and the local area network circuitry, wherein the MPC is further configured to communicate with the local area network circuitry through the sideband communication channel that is a lower speed and lower power channel than a high-speed communication channel between the local area network circuitry and the processing node.

17. The computing system as recited in claim 16, wherein each of the MPC and a packet processing circuit of the local area network circuitry utilizes an always-on power domain.

18. The computing system as recited in claim 16, further comprising a sideband input/output interface configured to communicate with the local area network circuitry through the sideband communication channel, wherein the sideband input/output interface is not configured to perform lane training.

19. The computing system as recited in claim 16, further comprising local memory, wherein the MPC is further configured to access the local memory for processing the first packet in place of accessing system memory of the processing node.

20. The computing system as recited in claim 16, wherein:
the MPC is further configured to send, via the sideband communication channel, a response to the local area network circuitry based on processing of the first packet by the MPC while each of the plurality of clients of the processing node remains in an idle state; and
the first packet is a remote monitoring packet requesting diagnostic information from one or more of the plurality of clients of the processing node.
